(19) United States
(12) Patent Application Publication
(10) Pub. No.: US 2008/0235600 A1
(43) Pub. Date: Sep. 25, 2008

(54) Interaction with a Display System

(75) Inventors: Richard Harper, Cambridge (GB); Gary Marsden, Cape Town (ZA); Andrew Maunder, Durbanville (ZA)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/690,670

(22) Filed: Mar. 23, 2007

(51) Int. Cl. G06F 3/00

(52) U.S. Cl. 715/748

(57) ABSTRACT

A method of interacting between a display system and a user device is described in which a number of images are displayed by the display system. A user captures one of the images using a camera on the user device and sends the captured image over a wireless link to the display system. Upon receipt, the display system determines the identity of the sending user device and analyses the received image, and if the image matches one of those displayed, the system sends any data associated with the displayed image to the user device over the wireless link. A user may also upload data to form a media package over the wireless link.

### BACKGROUND

Large screen displays are often located in public places, such as railway stations, public squares and at large events (e.g. concerts, festivals etc). Such displays are also often located in semi-public areas, such as the reception areas of companies. There are a number of known methods by which a user can interact with a large screen display such that the user can send content to the display and/or access content from the display. In a first example, a display device may be accessible at a particular URL and therefore a user may interact with the device over the internet using a web browser application, such as Internet Explorer (trade mark). However, this form of interaction may be unappealing to users because it feels very indirect and also there may be technical problems such as the unreliability of GPRS connections (for wireless devices), the difficulty in locating the correct URL, overloading of remote servers, etc. In a second example, a local wireless link may be used, such as a Bluetooth™ connection. This requires the pairing of the user's device to the display device, and this can be a relatively complicated process in which the user has to navigate through a complicated menu system on their device. In an attempt to overcome the pairing problem, some devices broadcast a single piece of content to any passing Bluetooth device. Not only does this deny user choice, but is irritating as the user did not initiate the communication. In a third example, client software installed on a user's device may enable the user to interact with the display device. However, whilst such software may make the interaction relatively straightforward for the user, it requires the client software to be already installed on the user's device. Furthermore, the client software is generally proprietary and therefore it may be necessary to have multiple clients installed if the user wishes to interact with a number of different large screen displays.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method of interacting between a display system and a user device is described in which a number of images are displayed by the display system. A user captures one of the images using a camera on the user device and sends the captured image over a wireless link to the display system. Upon receipt, the display system determines the identity of the sending user device and analyses the received image, and if the image matches one of those displayed, the system sends any data associated with the displayed image to the user device over the wireless link. A user may also upload data from the user device to the display device over the wireless link.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a system for interacting with a display;

FIG. 2 is an example flow diagram showing a method of interaction between the system of FIG. 1 and a user device;

FIG. 3 is an example flow diagram showing additional steps to FIG. 2;

FIG. 4 is a second example flow diagram showing a method of interaction between the system of FIG. 1 and a user device;

FIG. 5 is a schematic diagram showing the system of FIG. 1 connected to a communication network;

FIG. 6 is an example flow diagram of a method of providing content for the display system;

FIG. 7 is an example flow diagram of a method carried out by a remote user via remote user device;

FIG. 8 is an example flow diagram of a method of operating the scheduling system in FIG. 5;

FIG. 9 is a schematic diagram of another system for interacting with a display; and

FIG. 10 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

### An Exemplary System

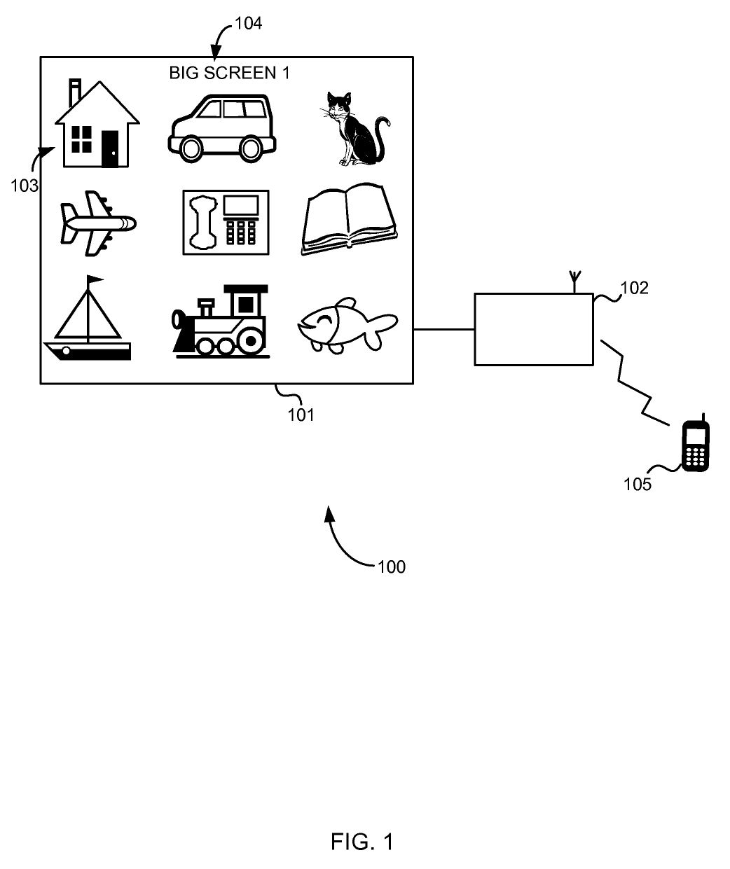

FIG. 1 is a schematic diagram of a system 100 for interacting with a display, such as a large screen display. The system enables a user to selectively request content from the display system and/or to upload content for display and subsequent download to other users. The system does not require special user devices or special applications to be running on the user device, but it does require that the user have a device with some kind of capacity to capture images and to send images via local wireless exchange protocols such as Bluetooth. At the current time, nearly all manufactured camera phones provide this as standard. The system 100 comprises a display device 101 connected to a computing device 102 which is wireless enabled. The display device 101 may comprise a large screen such as a plasma or LCD screen, a projector, or multiple display devices (e.g. several LCD screens or televisions arranged to form a larger display area). The computing device 102 may comprise a PC which is capable of transmitting and receiving Bluetooth signals.

The system is arranged to display a number of images 103 (nine images in the example of FIG. 1) on the display device 101, with some or all of the images having associated data, referred to herein as a ‘media package’ or ‘media pack’. The media packages (not shown in FIG. 1) may be stored on the computing device 102 (as described in more detail below) and downloaded to user devices upon request. In order to request a media package, the user takes a photograph of the related image and sends this image to the display system. Each media package may comprise one or more data elements (also referred to as ‘media objects’), where data elements may include video files, sound files, still images, SMS text, documents or any other form of data. These data elements may all be stored on the computing device 102, or alternatively an index of data elements in each media package may be maintained on the computing device with the individual data elements being stored in other locations which are accessible by the computing device 102. As described in more detail below, the different images may relate to different organizations, projects, news items, teams etc according to the application of the system. The system may also display a device name 104 (such as ‘BIGBOARD1’) on the display. In other examples, this name may be shown on the display surround (i.e. in a fixed manner) or no device name may be displayed. A user device 105, such as a Bluetooth enabled mobile telephone, can interact with the system 100 using Bluetooth signals, as described below, without requiring a custom application to be installed on the device.

The images 103, which may alternatively be referred to as icons, may be of any shape, although in many examples the images represent, in some manner, the content or type of content in the associated media package. These images may be generated by the system or provided along with the content for a media package by a user or other party.

### Exemplary Methods

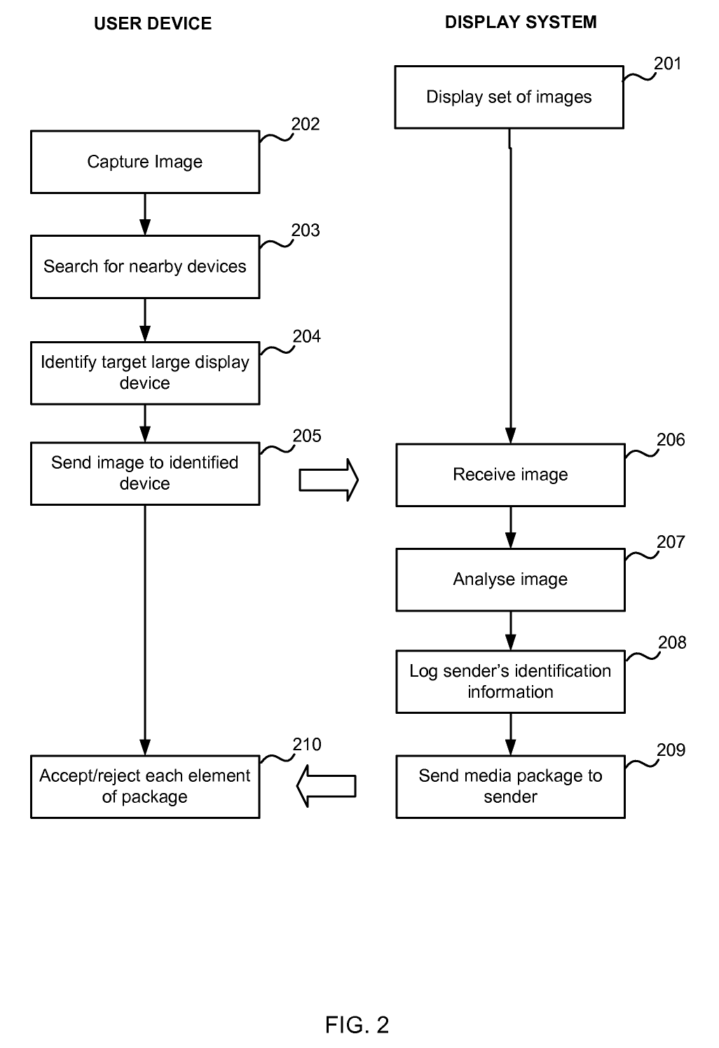

FIG. 2 is an example flow diagram showing a method of interaction between the system 100 and the user device 105. As described above, the display system 100 displays a set of images 103 on the display device 101 (block 201). If a user wishes to request the media package associated with one of the images, the user takes a photograph (i.e. captures a digital image) of one of the images displayed on the display device (block 202). In an example, a user may capture the top left image of a house displayed on the display device. The user device may then prompt the user to ‘save’ or ‘send’ the image and if the user selects ‘send’ they may further be prompted to select a sending method, such as ‘MMS’ or ‘Bluetooth’. If the user selects ‘Bluetooth’, the user device searches for nearby Bluetooth enabled devices (block 203) and displays a list of those devices found. From this list, the user can select the target large display device (block 204) and this may be assisted by the device name for the display system being prominently displayed (e.g. ‘BIGSCREEN1’ 104) or by the name being self-explanatory (e.g. ‘shoot and carry’, ‘large display’ etc). The image can then be sent by the user via Bluetooth to the identified device (block 205).

The display system 100 receives the image sent by the user device (block 206) and analyses the image (block 207) to determine whether the image received matches any of the images 103 displayed on the display device. Any suitable analysis technique may be used, such as bar codes within the image, color scaling or image shape criteria. The analysis is simplified by the fact that there are only a relatively small number of images displayed on the display device to which the received image need be compared. Depending on the analysis technique used, it may be necessary for the captured image to include the whole of one of the images and none of any other images, although in other examples, the analysis may be able to perform image matching when the captured image contains most of one of the images displayed (e.g. a portion of the image has been cropped by the capturing process as it was outside of the field of view) and/or when the captured image also contains a small portion of one or more of the other images displayed on the display device.

In addition to analyzing the image, the display system 100 automatically reads and records the identification information for the sender of the image (block 208). This identification information may comprise a unique Bluetooth identification number, a MAC address, or any other identification information which can be obtained from the message received which contained the image (received in block 206). Using current Bluetooth protocols it is not possible to obtain the sender's telephone number from the message, however, this may be possible in the future or if a different wireless protocol is used. In some examples, this additional user information may be available in a look-up table, particularly if the users are able to register for the service (e.g. to get additional services such as email alerts etc) and provide user information as well as Bluetooth ID on registration. Having identified (in block 207) which of the images displayed (in block 201) matches the image received (in block 206), the display system automatically sends any media package associated with the particular image to the sender (block 209) e.g. using Bluetooth and the stored identification information. By using the stored identification information, the display system can send content directly to the sender's user device without interfering with other Bluetooth enabled devices in the vicinity. Upon receipt of the media package from the display system, the user device may provide an alert (not shown in FIG. 2) and the user may be able to accept or reject each element of the media package individually (block 210) or alternatively the user may be able to accept or reject the media package in its entirety. There may be images with no associated media package, in which case no media package is sent (in block 209).

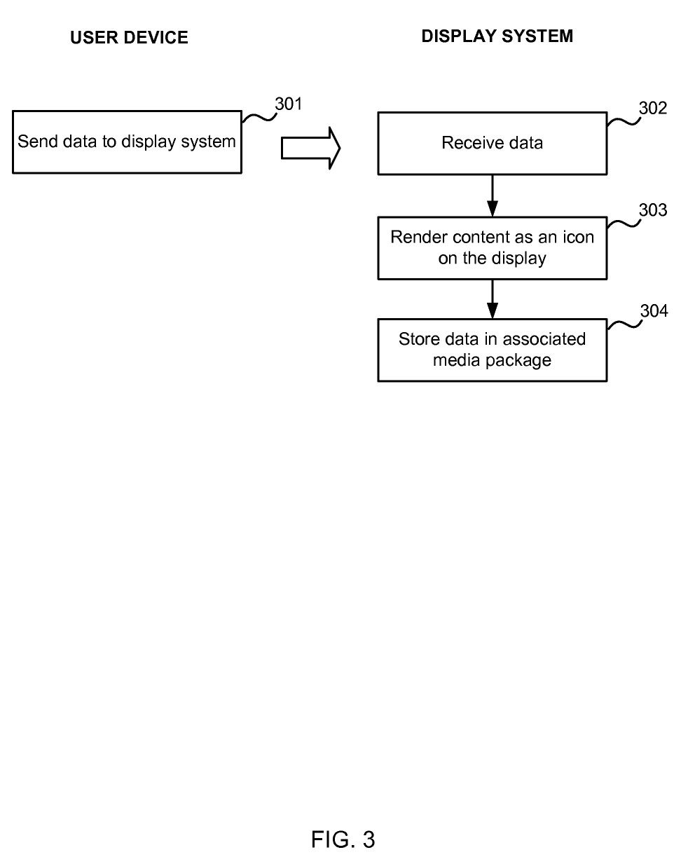

Subsequently, as shown in FIG. 3, the user may wish to upload some content to the display system. The user sends, using the user device and Bluetooth, the content to the display system (block 301). This sending process may be similar to the sending process described above (blocks 203-205) such that the user identifies the data, searches for nearby devices and identifies the display system (using the same name as used in block 204) before sending the data to the identified device. The display system receives the data (block 302) and analyses the data type the objects file extension. If the object is an image the display system renders the content as an icon on the display (block 303) and stores the data in a media package associated with the icon (block 304). Where the same user uploads multiple data elements to the display system (by repeating blocks 301-304), each data element may be collated in a single media package associated with the sender (e.g. through the identification information, as stored in block 208 and identifiable from subsequent messages received from the sender). The icon may remain the same when subsequent data elements are uploaded to a media package or may be replaced or modified.

Elements within a media package may be stored in a common location or alternatively, when new data elements are added to a media package, a table may be updated which identifies the contents of a media package and the storage location of each element.

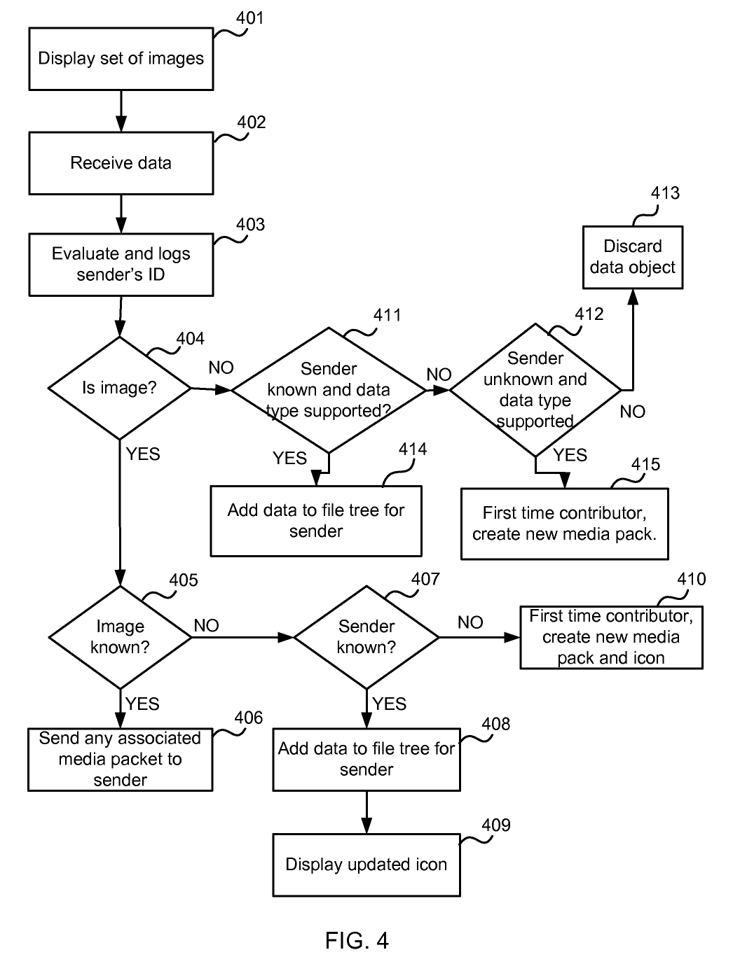

FIG. 4 is another example flow diagram showing a method of interaction between the system 100 and the user device 105. Whilst FIG. 4 only shows the operation of the display system 100, the operation of the user device will be similar to that shown in FIGS. 2 and 3. A set of images 103 are displayed on the display device 101 (block 401). Upon receipt of data from a user device (in block 402), the system evaluates and logs the user's device's (i.e. the sender's) ID (block 403) or other identification information. The system analyses the received data to determine if it comprises an image (block 404) and the image is known (block 405), i.e. one of the images 103 displayed on the display device 101. This analysis may use any suitable method, as described above with reference to block 207. If the data does comprise a known image (“Yes” in both blocks 404 and 405), the system sends any associated media package to the sender (block 406). The user may then accept /reject element of the media package, or the media package as a whole, as described above with reference to block 210. There may be images with no associated media package and in this case, no media package is sent to the sender.

If the data comprises an image (“Yes” in block 404) but the image is not known (“No” in block 405, i.e. the data does not correspond to any of the images displayed on the display device), the system 100 determines whether the sender (as logged in block 403) is known (block 406) i.e. whether the sender has previously sent a data object to the system (e.g. as received in block 206 or 402 resulting in the logging of the sender's ID in block 208 or 403). This determination (in block 407) may comprise a comparison between the logged sender's ID (from block 403) and a database (or log) of senders who have previously sent known images to the display system (which may be referred to as an access list). If the sender is known (“Yes” in block 407), the data received (in block 402) is added to the media package associated with that sender (block 408). A file tree or index of data elements within the media package may be updated to include the additional data element(s). The image (or icon) associated with the media package for the sender and which is displayed on the display device may be updated (block 409) to reflect the new data received. This may include changing the image (or icon) displayed such that the new image relates to the new data or updating the icon such that it references the new data (e.g. in a list underneath the main image). In another example, the image may not be changed (block 409 does not occur).

Where the sender, whilst being known (“Yes” in block 407) has not sent any data previously to the system, there may be no existing media package associated with the sender and no image associated with the sender displayed on the display device. In this situation a new media package comprising the data received is created (in block 408) and a new image icon generated and displayed which is associated with that media package (in block 409). In some examples, the image for display on the display device may be provided by the user as part of the uploaded data.

If the sender is not known (“No” in block 407), i.e. they have not previously sent a data object to the display system, the data received (in block 402) is added to a newly created media package for that sender (block 410) and the sender's ID is added to the stored list of senders.

In some cases, the received data object may be another object type such as video, audio or text and not an image (“No” in block 404). The display system will then search for previously logged sender identification information that matches the identification information contained in the received data object. If the sender is known (“Yes” in block 411), the data object will be added to the senders existing media package (block 414). Should the display system be unable to find a matching media package (“No” in block 411), the display system will treat the sender as a first time user and will create a new media package with the received data object included (block 415). The media pack created (in block 415) may or may not be displayed immediately, depending on how the display system is configured. The system may wait for an image to be uploaded for use as an icon or if the system configuration requires the media package to be immediately displayed, an icon may be generated. If the data object is not supported by the display system, it is discarded (block 413).

In another example method, a user may not be permitted to upload data unless they have previously sent a known image to the display system. In this example, in order to enable a user to upload content to the display system without first receiving a media package, one of the images 103 displayed on the display device may not have an associated media package. The image may be such that it is clear to a user that this is the icon to photograph in order to be able to upload content without receiving any content from the display system. In such an example, the method of FIGS. 2 and 3 may be modified such that no media package is sent to the sender (i.e. block 209 does not happen) but otherwise the method may proceed as described above. In another such example, the method of FIG. 4 may be modified such that if the sender is unknown (“No” in block 407 or 411) the data object is discarded (as in block 413).

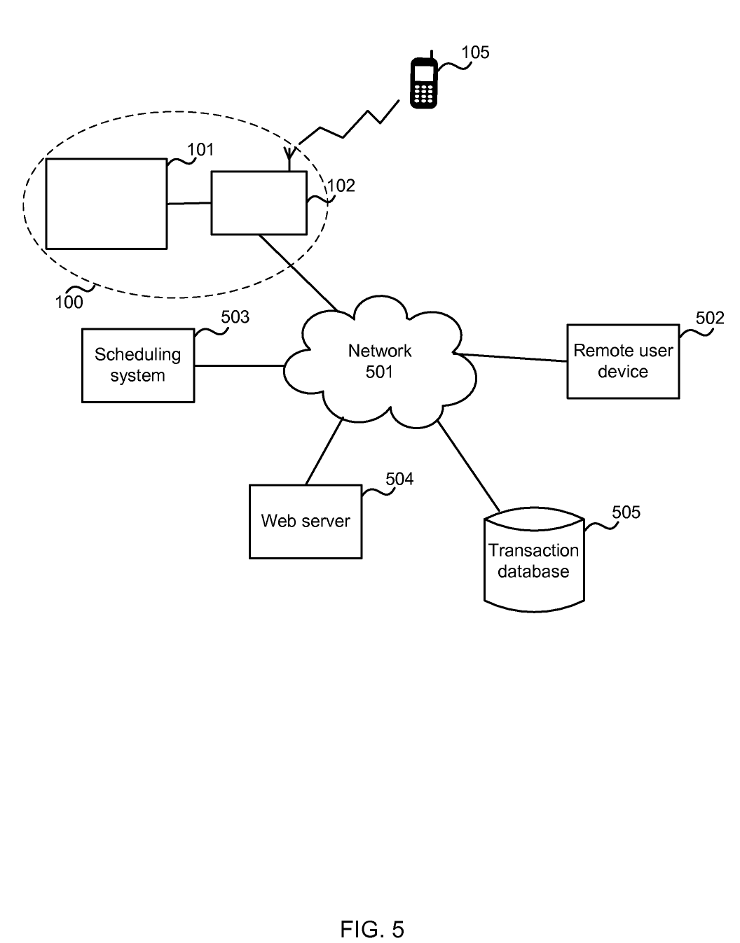

In addition to, or instead of, allowing users to upload data to generate media packages associated with their sender ID as described above, media packages may be provided by the display system provider or by other entities, such as companies, corporations, public bodies etc. The data for a media package may be provided in any way to the display system provider so as to enable them to store and subsequently send the media package to users upon request (where the request constitutes the message containing the appropriate captured image). One example method is described in European patent application 06270001.8 filed Jan. 8, 2006 and entitled ‘Situated Display System’, which is incorporated herein by reference in its entirety. This method is described below with reference to FIGS. 5-8.

The display system shown in FIG. 1 may be connected to a communication network 501 as shown in FIG. 5. As shown in FIG. 1, the display device is arranged to display a number of images 103 and the display device may be considered to be divided into a number of regions (nine regions in FIG. 1) each of which is capable of being filled by an image, which may have an associated media package, as described above. Some or all of the regions may each be associated with a unique address. The unique addresses may be of any suitable type such as subscriber identity modules (SIMs), IP addresses, URIs, URLs, email addresses, conventional telephone addresses, global positioning system co-ordinates or other addresses. A remote user has access to the display system 100 using via remote user device 502 and the communications network 501 (which may be the internet). The remote user device 502 may be a mobile communications device, any other suitable type of communications device or an automated service without an associated human user.

Information about the unique addresses of the display regions may be made available over the communications network 501. This can be provided by the computing device 102 or any other suitable database accessible via the communications network 502. In an example the address information may be provided by a scheduling system 503, which may be used by the remote user device 502 either directly or via a web service provided using a web server 504. The scheduling system allows the remote user to obtain information about availability of display screen regions and optionally other information such as display options available at those regions (for example, what colors are available) and information about content already or planned to be displayed concurrently at other display regions. The scheduling system may also provide pricing information about prices of display regions for particular time periods. Using the scheduling system the remote user, via remote user device 502 may be able to book, or purchase display region time. Optionally, the scheduling system 503 may also comprise a pricing module arranged to dynamically determine prices for display regions on the basis of demand for those regions.

A transaction database 505 may also be connected via the communications network 501 and may receive and store information about display events where content is displayed on particular regions. This information can comprise for example, information about prices paid for display, information about the type of content, information about the remote user concerned and information about the display event itself. This may include for example, the duration of display, the identity of the display regions used, the time of day the display occurred, the use or not of color preferences and other factors. The transaction database can then be used for billing purposes, for forecasting, for price determination, or for any other suitable purpose.

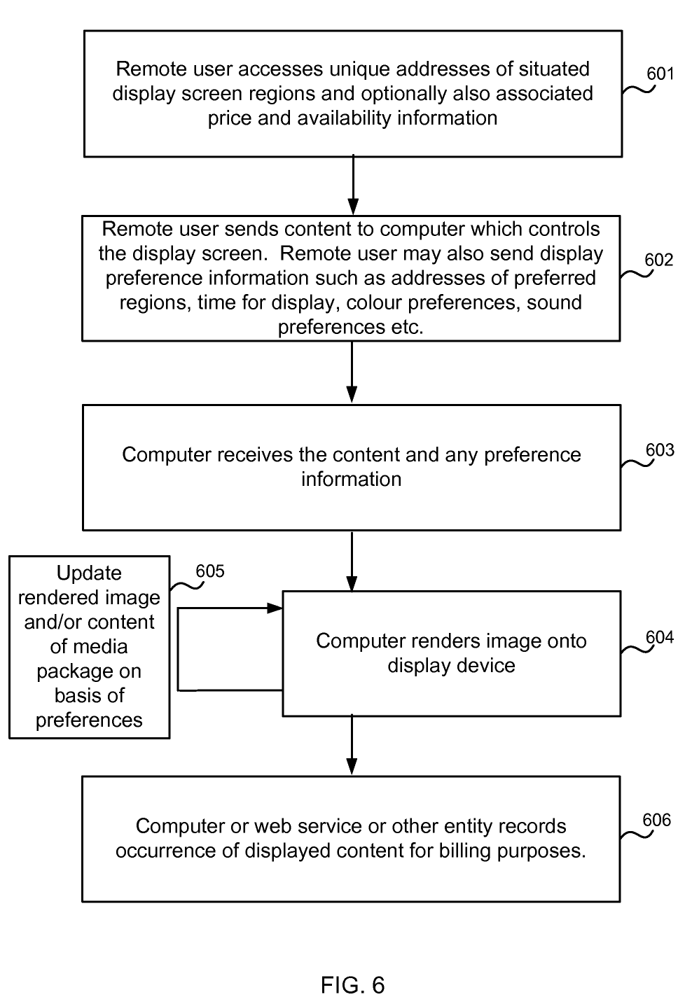

FIG. 6 is an example flow diagram of a method of providing content for the display system. A remote user (via user device 502 in FIG. 5) accesses information about display regions in any suitable manner (block 601). For example, using a web service via which web pages are presented which enable the remote user to interact with the scheduling system to request and book display regions. In other examples, the information may be obtained by accessing the information from any suitable database linked to the communications network or by using pre-specified information. For example the information comprises the unique addresses of one or more display regions and optionally other information such as price and availability information for display screen regions and information about what types of display are available, color options, etc.

The remote user may then collate and send content items via the user device 502 for display on the display device 101 (block 602). The content items can be of any suitable form such as image files, text files, sound files, text messages, email messages, MMS messages, or other. The content items may be either sent directly to the computing device 102 controlling the display 101 or to a forwarding entity arranged to forward the content items to the computing device. In one embodiment the remote user may obtain the unique address of one of the display regions and the remote user is then able to use the address to send content directly to the particular display region. In that case, the computing device 102 comprises policing functionality to ensure that only display regions that have been appropriately booked and paid for can be used and optionally also automatic filtering means to check that the content items are appropriate for display (e.g. any image provided) and download (e.g. the content of the media package). In another embodiment, the remote user does not have access to the unique addresses but rather sends the content items for display via a forwarding entity. This enables the unique addresses to be hidden from the remote user to prevent inappropriate use of those addresses.

In the case that the remote user has access to the unique addresses that remote user is able to send content to the computing device 102 and may also send display preference information such as times for display, color preferences, sound preferences etc. The computing device 102 receives the content items and preferences (block 603) and stores the content as a media package. The computing device renders an image representing that content onto the display screen (block 604). The image rendered may have been provided by the user (e.g. received in block 603) or may be generated by the computing device. In another example, the user may be able to select an image to be used from a set of possible images provided by the display system. Where the image is provided by the user, a best fit is made of the image provided into the display region specified by the unique addresses and using any color, style or other preferences indicated. As described above, where the image is provided by the user, it may be checked to ensure that it is not inappropriate, offensive or that it should not be used for any other reason.

The computing device 102 may repeatedly update the rendered image and/or the content of any associated media package on the basis of the preferences (block 605) and any additional content provided (e.g. through repeating blocks 602 and 603). For example, if a display region has been reserved for a time period of one hour the display is updated to remove the image from the region after that time. The computing device or other entity may record the occurrence of the displayed content for billing or other purposes (block 606).

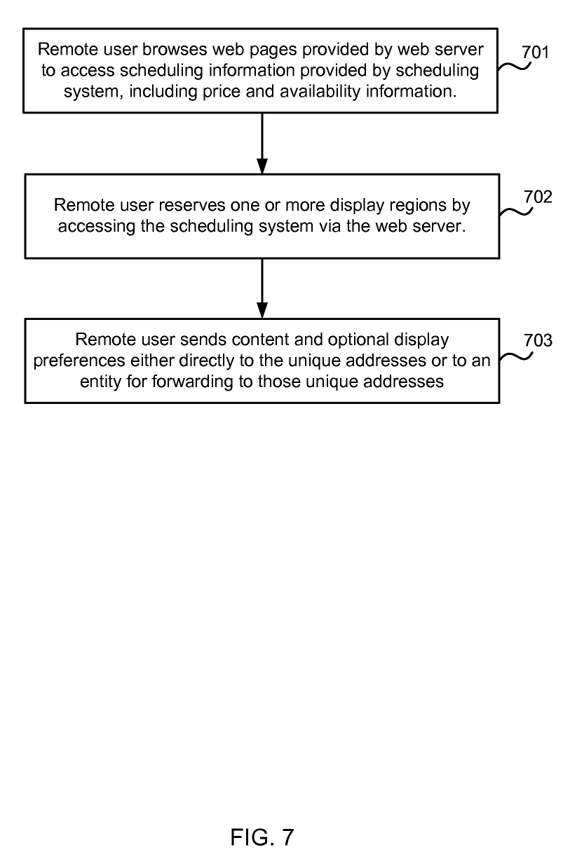

FIG. 7 is an example flow diagram of a method carried out by a remote user via remote user device 502. The remote user may browse web pages provided by a web server 504 (in FIG. 5) to access scheduling information provided by a scheduling system 503, including price and availability information (block 701). The scheduling system may provide a web-based user interface that enables the remote user to easily view this information and to reserve one or more display regions (block 702). The remote user then sends the content and optional display preferences either directly to the unique addresses concerned or to an entity for forwarding to those unique addresses (block 703). The entity for forwarding can be any suitable type of re-direction server, the scheduling system, the web server 504, the transaction database 505 or other communications network node.

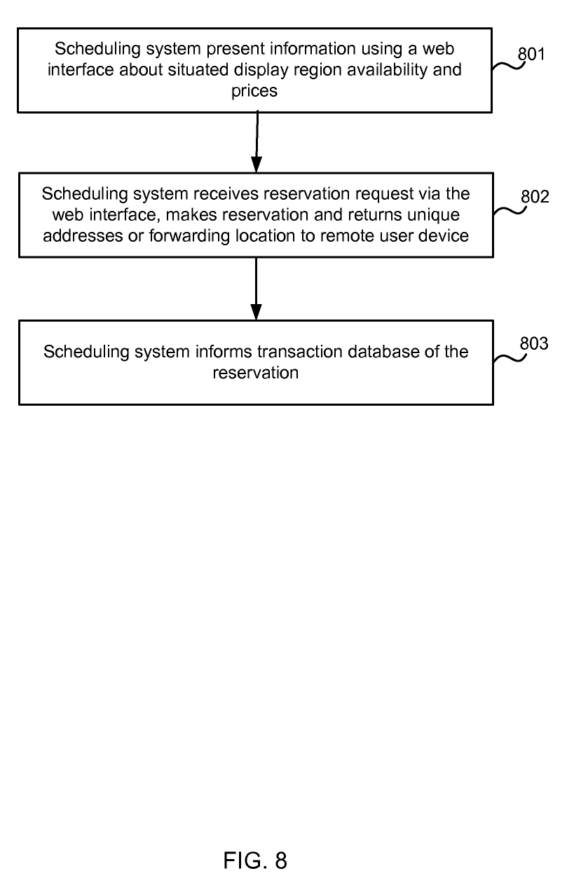

FIG. 8 is an example flow diagram of a method of operating the scheduling system 503 of FIG. 5. This scheduling system 503 presents information using a web interface about situated display region availability and prices (block 801). The scheduling system receives a reservation request via the web interface, makes a reservation and returns unique addresses or forwarding location information to the remote user device 502 (block 802). The scheduling system 503 then informs the transaction database 505 of the reservation (block 803).

With users being able to upload content to the display system, the number of media packages, and therefore images to be displayed, may exceed the number which can be displayed on the display device at one time. In such a situation, a subset of images may be selected for display at any one time based on criteria such as the age of the data elements (with those images with associated media packages which have been more recently updated being displayed in preference to other images) or a defined quota (e.g. a proportion of the images may be shown at all times whilst the remaining images may be associated with user uploaded media packages and groups of these may be shown in sequence).

The ability of users to upload material to a display system may be controlled through the list of known senders (described above) or other access list. By only adding data to a media package for those senders with senders IDs that are included on the relevant list, data uploaded by malicious or unauthorized senders will be discarded. Malicious senders may include those who send or attempt to send inappropriate material, corrupted material, viruses etc to the system. A check of the data uploaded may be performed before it is added to the media package (e.g. between blocks 302 and 304, between blocks 407 and 408, between blocks 411 and 414 or between blocks 412 and 415).

In an alternative system, a list of blocked senders may be maintained (which may be instead of or in addition to the list of known senders or the access list) and data received from these senders may be automatically discarded. Additionally, in some examples, the identification information for those senders which are identified as malicious may be automatically forwarded to the mobile telephone network operators. The operators may be able to identify the particular user from the identification information and subsequently restrict access or send them a complaint notice.

It will be appreciated that whilst some systems may allow users to upload data, some systems may be such that they send media packages to users but do not allow users to upload data to form user provided media packages. Such systems may operate as described above in relation to FIG. 2 or FIG. 4 blocks 401-406.

### Another Exemplary System

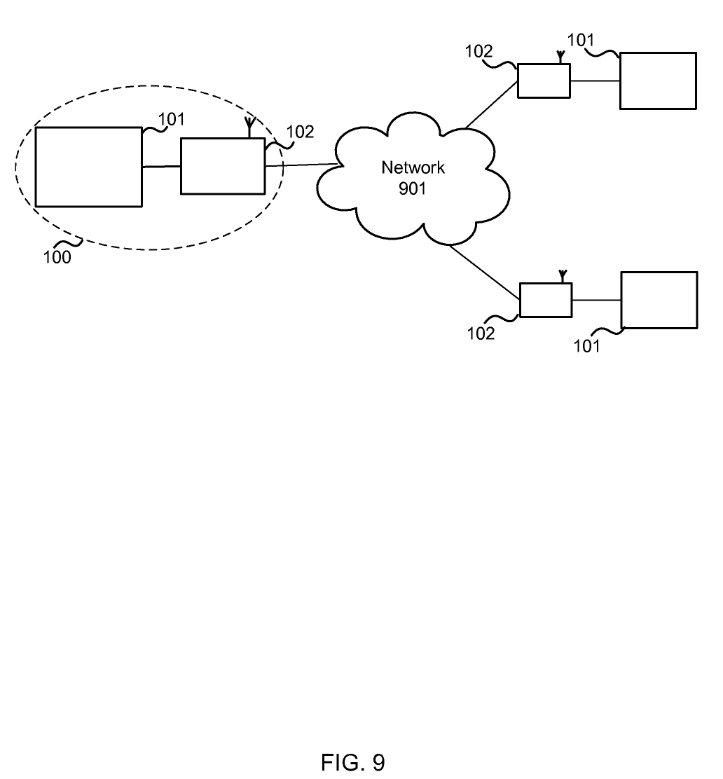

FIG. 9 is a schematic diagram of another system 900 for interacting with a display, such as a large screen display. The system 900 comprises a number of the systems 100 described above, each comprising a display device 101 and a computing device 102, connected together over a network 901, such as the internet, intranet or a local area network. The individual systems 100, which may operate as described above, may communicate with each other such that they share a common list of known senders. This enables a user who has captured an image from one display device 101 and sent it to the corresponding computing device 102 can subsequently upload data to any of the display systems 100.

Each of the individual display systems 100 in the networked system 900 may display the same set of images or alternatively the systems may show different sets of images. Where users upload data to one of the display systems, this data may be collated into a media package for display and subsequent access only from that display system, or alternatively, user uploaded content may be collated into a single media package irrespective of which individual display system it was uploaded to and the media package may be available for download (via a displayed image) from one or more of the individual display systems 100.

Media packages (or the data elements of which they are comprised) may be stored in a distributed manner on the individual computing devices or alternatively some or all of the data elements may be stored on one or more central storage elements which are accessible by the individual computing devices over the network.

It will be appreciated that the system 900 in FIG. 9 may also comprise additional elements, such as the web server, scheduling system and transaction database as shown in FIG. 5.

### Exemplary Applications

In a first example application, the display device may comprise a large LCD screen installed in a public area of a company or research laboratory. Images may be displayed which represent different teams, projects or products which relate to the company or research laboratory where the device is located. Visitors to the location may choose to take home an information pack (i.e. a media package) which relates to one or more of the teams/projects/products for which images are displayed. This can be achieved by the visitor capturing an image of the relevant displayed image (or icon) and sending the image to the device (as described above). The device then automatically sends the appropriate media package to the visitor's user device. The media packages may be updatable by employees of the company (or other authorized people) by accessing the media package via the web, the intranet or by other means.

In a second example application, a large screen display may be located in a public place such as a shopping mall or public square. Retailers may be able to provide media packages that enable passers-by to access the information which may include movie clips, directions, menus, details of special offers, coupons etc. The ability for retailers to display an image and provide media packages to the public upon request may be monetized using the techniques described above with reference to FIGS. 5-8, in which the screen real estate is divided into zones each of which is associated with a unique SIM, URL or other address and by which access is made available to third parties over time whilst under the control of the screen owner.

In a third example application, the large screen display may be used to provide public information, such as welfare information, information about local services etc. The system described above may be particularly suitable for use in countries, such as developing countries, where the most prevalent computing device is a mobile telephone and where a mobile telephone may be the only computing device for a large proportion of the population. Using a networked system, such as that shown in FIG. 9, in combination with the ability to remotely manage the images being displayed and the content of the media packages (e.g. as described above with reference to FIGS. 5-8) enables entities such as government agencies, community organizations and non-governmental organizations (NGOs) to provide content to the mass of users by positioning display devices in public areas such as in townships, railway stations, villages, town squares, health centers etc. Using the methods described above, all traffic and file exchange is free at the point of delivery, although monetization can be imposed on those who provide media packages. Users do not require any special client software running on their mobile telephones and the methods enable content to be requested in a non-complicated and intuitive manner.

It will be appreciated that these applications provide just three examples and many other applications exist. Aspects of any of the applications described may be combined in any way, for example, a display device may have a public service portion (e.g. three images out of a total of nine) and a portion which enables third parties to pay to provide media packages (e.g. the remaining six images). In other situations, such as at a pop concert or other large public event, a small number of images may provide public service information whilst the majority of the display space may be available for user uploaded content.

### An Exemplary Computing Device

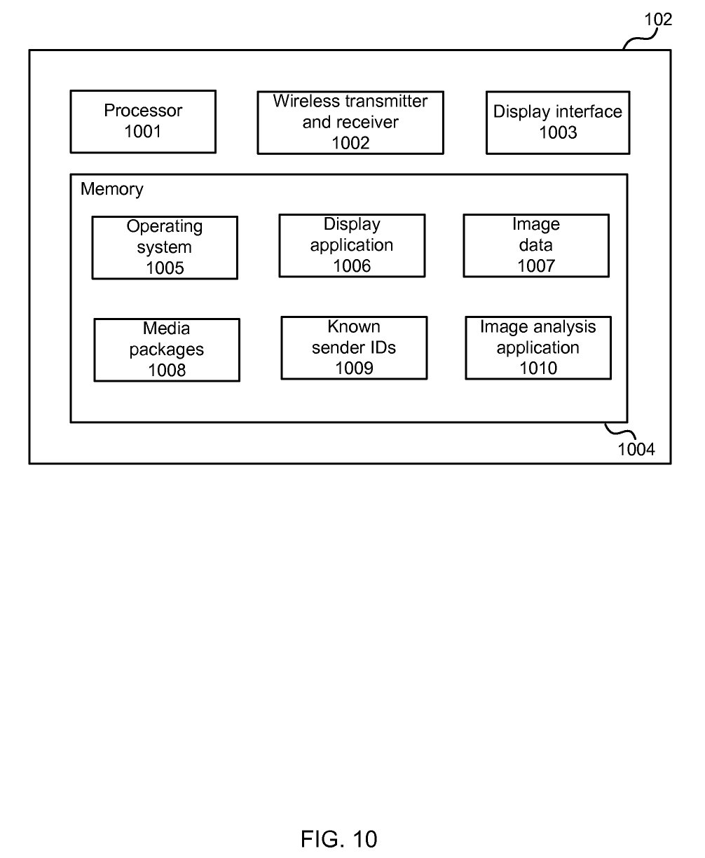

FIG. 10 illustrates various components of an exemplary computing device 102 which may be implemented as any form of a computing and/or electronic device, and in which embodiments of the methods described above may be implemented.

Computing-based device 102 comprises one or more processors 1001, a wireless transmitter and receiver 1002 (or wireless transceiver), a display interface 1003 and one or more data storage elements, shown in FIG. 10 as memory 1004. The processor(s) 1001 may be microprocessors, controllers or any other suitable type of processors for processing computing executable instructions to control the operation of the device in order to perform any of the methods described above. The wireless transmitter and receiver 1002 may use any suitable wireless technology and protocol, such as Bluetooth. The display interface 1003 is arranged to output a signal to cause the required images 103 to be rendered on the connected display device 101, as shown in FIG. 1.

The memory 1004 may be any computer-readable media, such as memory of any suitable type, for example, random access memory (RAM), a disk storage device of any type such as a magnetic or optical storage device, a hard disk drive, or a CD, DVD or other disc drive. Flash memory, EPROM or EEPROM may also be used. The memory may be arranged to store platform software comprising an operating system 1005 (e.g. Microsoft Windows or Vista™) and a display application 1006 comprising executable instructions to cause the processor to perform some or all of the method steps described above. The memory may also store the image data 1007, media packages 1008 and known sender IDs 1009, although some or all of this information may be stored elsewhere (e.g. in a central repository which is accessible by the computing device 102 over a network). The memory may, in some examples, also be arranged to store an image analysis application 1010 although the image analysis code may alternatively be incorporated within the display application 1006.

It will be appreciated that the computing-based device 102 may include one or more additional elements not shown in FIG. 10, such as a network interface (e.g. to enable connection to network 501 or 901), an interface to a user input device such as a mouse and/or keyboard and various other inputs and/or outputs.

### CONCLUSION

Whilst the above examples describe the use of Bluetooth signals to transmit data between the display system and the user device, it will be appreciated that alternative wireless technologies may be used, such as WiFi or infra-red. Suitable technologies include those which are relatively short range (a range of meters rather than kilometers) and have low/no latency. For some applications, technologies which are free to use may be particularly suitable.

In the above examples, the user device is described as a mobile telephone. However, it will be appreciated that the user device may be any device having a camera and being capable of communicating wirelessly with the display system. Other suitable user devices include PDAs (personal digital assistants) with cameras, digital cameras with wireless (e.g. Bluetooth) capability, laptop or tablet computers etc. Whilst all these devices are portable, the user device may in some examples be non-portable however this may be impractical.

The methods described above involve a manual operation in which the user selects the device to which the captured image should be sent (block 204 of FIG. 2) and this selection is aided by labeling on the display device (such as label 104 in FIG. 1) and/or by appropriate naming of the display system (e.g. “DISPLAY BOARD” or “IMAGE UPLOAD HERE”). However, if the image capture application on the user device 105 includes image analysis capabilities, the user device may be able to identify the target device (in block 204) without manual user intervention. For example, the captured image may include a bar code or other pattern which may encode a small amount of data, such as the device name of the display system 100. In another example, the image analysis capabilities may include text recognition and the images displayed may include the device name in text.

In another example, the name of the display system may be communicated by the system to wireless devices which are in the vicinity. This may be achieved via Bluetooth (where the user devices are visible to the system), SMS message or any other technique.

Whilst in the above examples, the media package is provided to the user device using the same wireless technology that was used by the user device to send the captured image to the display system (e.g. Bluetooth), in some examples the media package or supplementary data may (in addition or instead) be provided using another communication means, such as email, WAP push, SMS or MMS message etc. Where a networked system is used (e.g. as shown in FIG. 9), the data may be transmitted by a central network element rather than the specific display system 100 which received the request from the user device.

In the description above and FIGS. 1, 5 and 9 the display device 101 and the computing device 102 are shown as two separate elements which are connected together. It will be appreciated that in some examples the two functional elements may be integrated into a single device. In some examples, multiple display devices 101 may be connected to a single computing device 102. In this situation, there may be a single wireless transmitter and receiver connected to the computing device or there may be multiple transmitters and/or receivers (e.g. one mounted in or near each display device).

It will be appreciated that whilst the methods described above show a user requesting a single media package, the methods may be repeated such that multiple media packages may be requested and subsequently received and/or multiple data elements may be uploaded to a display system.

Although the present examples are described and illustrated herein as being implemented in a stand alone system 100 or a networked system 900, the system described is provided as an example and not a limitation. As those skilled in the art will appreciate, the present examples are suitable for application in a variety of different types of communications systems.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person. Elements from any of the embodiments or examples described herein may be combined in any way with elements from any of the other embodiments or examples so as to create further embodiments.

It will be understood that the benefits and advantages described above may relate to one embodiment or may relate to several embodiments. It will further be understood that reference to ‘an’ item refer to one or more of those items.

The steps of the methods described herein may be carried out in any suitable order, or simultaneously where appropriate. Additionally, individual blocks may be deleted from any of the methods without departing from the spirit and scope of the subject matter described herein.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of interacting with a user device comprising:
displaying a plurality of images;
receiving a message from said user device comprising data and identification information for said user device;
reading said identification information;
comparing said data to said plurality of images; and
if said data comprises a captured image of one of said plurality of images, sending any media package associated with said one of said plurality of images to said user device.

2. A method according to claim 1, further comprising:
receiving a second message from said user device comprising data and identification information for said user device;
displaying an image associated with said data from said second image; and
storing said data from said second image in a media package associated with said identification information for said user device.

3. A method according to claim 1, further comprising:
if said data comprises a captured image of one of said plurality of images, adding said identification information to an access list.

4. A method according to claim 1, further comprising, if said data does not comprises a captured image of one of said plurality of images:
determining if said identification information is included in an access list; and
if said identification information is included in said access list, displaying an image associated with said data; and storing said data in a media package associated with said identification information for said user device.

5. A method according to claim 4, wherein displaying an image associated with said data comprises:
generating an image associated with said data; and
displaying said image.

6. A method according to claim 4, wherein storing said data in a media package associated with said identification information for said user device comprises:
storing said data; and
adding a record for said data to a file tree associated with said identification information.

7. A method according to claim 4, further comprising:
if said identification information is not included in said access list, discarding said data.

8. A method according to claim 4, wherein said access list comprises a list of identification information corresponding to messages received which comprise a captured image of one of said plurality of images.

9. A method according to claim 1, wherein said message is received over
a wireless link and wherein sending any media package associated with said one of said plurality of images to said user device comprises:
sending any media package associated with said one of said plurality of images to said user device over said wireless link using said identification information.

10. A method according to claim 9, wherein said wireless link comprises a Bluetooth link.

11. A method according to claim 1, further comprising, at said user device:
capturing one of said plurality of images;
sending said message, wherein said data comprises said captured image; and
receiving said media package.

12. A method of interacting with a user device, the method comprising:
displaying a plurality of icons on a display system;
on receipt of a message comprising data from the user device, comparing said data to the plurality of icons displayed; and
if said data comprises an image corresponding to one of the plurality of icons, sending any stored data associated with said one of the plurality of icons to the user device.

13. A method according to claim 12, further comprising:
adding said user device to an access list.

14. A method according to claim 13, further comprising:
if said data does not comprise an image corresponding to one of the plurality of icons, determining if the user device is on said access list; and
if said user is on said access list, displaying a new icon on the display system, storing said data and associating said data with said icon.

15. A display system comprising:
a display device; and
a computing device,
wherein said computing device comprises:
a processor;
a wireless transmitter and receiver;
a display interface; and
a memory arranged to store executable instructions arranged to cause the processor to:
receive a message from said user device comprising data and identification information for said user device;
read said identification information;
compare said data to said plurality of images; and
if said data comprises a captured image of one of said plurality of images, send any media package associated with said one of said plurality of images to said user device.

16. A display system according to claim 15, wherein said wireless transmitter and receiver comprise a Bluetooth transmitter and receiver.

17. A display system according to claim 15, wherein said display device comprises a large screen display.

18. A display system according to claim 15, wherein said memory is further arranged to store executable instructions arranged to cause the processor to:
receive a second message from said user device comprising data and identification information for said user device;
display an image associated with said data from said second message; and
store said data from said second message in a media package associated with said identification information for said user device.

19. A display system according to claim 15, wherein said memory is further arranged to store executable instructions arranged to cause the processor to:
if said data does not comprises a captured image of one of said plurality of images:
determine if said identification information is included in an access list; and
if said identification information is included in said access list, displaying an image associated with said data; and storing said data in a media package associated with said identification information for said user device.

20. A display system according to claim 15, further comprising:
a second display device; and
a second computing device,
wherein said computing device and said second computing device are connected via a network.
